(19) United States
(12) Patent Application Publication
(10) Pub. No.: US 2002/0101885 A1
(43) Pub. Date: Aug. 1, 2002

(54) JITTER BUFFER AND METHODS FOR CONTROL OF SAME

(76) Inventors: VLADIMIR POGREBINSKY, BAT-YAM (IL); NOAM CASTER, TEL-AVIV (IL)

Correspondence Address: WELSH & FLAXMAN LLC, 2341 JEFFERSON DAVIS HIGHWAY, SUITE 112, ARLINGTON, VA, 22202, US

(21) Appl. No.: 09/267,350

(22) Filed: Mar. 15, 1999

(51) Int. Cl. H04L 12/56

(52) U.S. Cl. 370/516; 370/517

(57) ABSTRACT

There is disclosed a method and apparatus for controlling the size of a jitter buffer in an audio receiver. The method an apparatus are such that network jitter can be distinguished from burst periods, where a large number of data packets (or packets) are transmitted rapidly. This method comprises the steps of monitoring the network for at least one burst period and then determining a likelihood for at least one subsequent burst period from this at least one burst period. The jitter buffer size is then adjusted based on the likelihood of this subsequent burst period. Apparatus for performing these method steps is also disclosed.

### FIELD OF THE INVENTION

The present invention relates to an audio receiver for use with communication networks and in particular to methods and apparatus for adjusting a jitter buffer to an optimal size for playing audio, that has been transferred over unstable networks.

### BACKGROUND OF THE INVENTION

Communication networks, such as wide area networks (WAN), are commonly known, and perhaps the fastest growing of these is the Internet. One Internet application, known as multimedia transceiver, enables users to transmit and receive audio, video and data over the Internet. An example of this application, known as Internet telephony client, allows for telephone calls over the Internet.

Audio may be transmitted in streams of packets over the Internet. The Internet, as well as other communication networks, has regular jitter, defined in Schulzrinne, et al., “RTP: A Transport Protocol For Real-Time Applications”, Network Working Group IETF, Request for Comments (RFC): 1889, January 1996, available at http://www.ietf.org/rfc/rfc1889.txt, hereinafter referred to as “RFC 1889”. Jitter for the Internet is for example, 100 milliseconds. To compensate for this network jitter, the receiver typically includes a jitter buffer, that controls packet transmission rate. An exemplary jitter buffer is disclosed in commonly assigned U.S. Pat. No. 5,825,771, the disclosure of which is incorporated by reference in its entirety herein.

FIG. 1 is exemplary of jitter in a network, for example, the Internet. In this Figure, jitter is shown as a line 20. Accordingly, the size of the jitter buffer may be set to 30 milliseconds, to accommodate this jitter.

Jitter buffer size is typically set in accordance with a bit rate of transferred audio packets. Changes in jitter buffer size effect audio quality. In particular, reducing jitter buffer size reduces delay of playing audio packets, but causes breaks in the audio transmission, when the amount of audio packets transmitted exceeds jitter buffer size. Oppositely, increasing jitter buffer size helps to inhibit breaks in the audio, but increases delay. The balance between audio break-up and delay is easily established in stable networks. This is not so for unstable networks such as the Internet, that may have bursts, also known as burst periods, where large numbers of packets are transmitted in extremely short time segments, as detailed in FIG. 2. These bursts result in spikes on a chart of network behavior, such as that detailed in FIG. 3, with the spikes occurring at time intervals 3 and 8.

FIG. 2 details on unstable network, such as the Internet, represented by the number of packets versus time (in milliseconds). Here, single packets of time length 10 are transmitted in equal intervals from transmission times 20, 40 and 60, in a “normal” transmission. Between time 70 and time 170, there is a silence period. This silence period may be due to many factors, one common factor being that one of the routers along the packet transmission path is busy. As a result, a transmission of 7 packets, beginning at time 170, is immediately followed, at time 180, by a transmission of five packets, followed immediately by single packet transmissions at times 190 and 200. This rapid transmission of a large number of packets is exemplary of a burst, or burst period (between times 170 and 210). Packet transmission returns to “normal” at time 220.

FIG. 3 shows two bursts (burst periods) graphically, along line 30 (formed of diamond shaped points) as spikes, occurring between time interval 2 and 4 and time interval 7-9. In this unstable network, exemplary of unstable networks, jitter buffer size, line 31 (formed of square shaped points) is continuously increased and reduced in size to keep the delay low, or alternately increase the delay, in order to overcome a burst of packets.

A major drawback to contemporary systems and methods for adjusting jitter buffer size is that these systems and methods do not distinguish between jitter and spikes, and thus, treat them similarly. When coupled with typical methods and systems that adjust jitter buffer size, some packets never arrive at is the receiver or arrive incompletely. This results in insufficient audio quality.

### SUMMARY OF THE INVENTION

The present invention improves on the prior art jitter buffer control mechanisms by providing methods and apparatus for adjusting jitter buffer size of audio transceivers for unstable networks. These methods involve estimating jitter buffer size based on the likelihood of a burst period by analyzing the receipt of network packets, with the apparatus including hardware and software for performing the same. The present invention operates by distinguishing burst periods from jitter, and adjusting the jitter buffer differently to accommodate these burst periods when compared to adjustments for jitter.

The present invention is directed to a method for controlling jitter buffer size for a jitter buffer of a communication device for communication with a network. This method comprises the steps of monitoring the network for at least one burst period, where a large number of data packets or packets are transmitted rapidly, and then determining a likelihood for at least one subsequent burst period from this at least one burst period. The jitter buffer size is then adjusted based on the likelihood of this subsequent burst period.

The method, also includes measuring a time to play for each packet received at a predetermined location and building a time to play statistic by creating at least two statistics from each of the received packets from at least two predetermined time intervals. Width and offset values are then calculated from each of the at least two statistic, and from these calculated values, the likelihood of the at least one subsequent burst can be determined.

The present invention is also directed to an audio receiver for use with a network, such as the Internet, having a jitter buffer and a controller for controlling jitter buffer size. The controller preferably includes a microprocessor or other similar computing means, programmed to monitor the network for at least one burst period and adjust the jitter buffer size (by signaling the jitter buffer) based on the monitoring of the network for at least one burst period, to accommodate packet transmissions in a burst period.

### BRIEF DESCRIPTION OF THE DRAWINGS

The present invention will be described with reference to the accompanying drawings, wherein like reference numerals and/or characters identity corresponding or like components. In the drawings:

FIG. 1 is a chart of jitter versus time in a communication network;

FIG. 2 is a chart of number of packets versus time to illustrate a burst or burst period;

FIG. 3 is R chart detailing the operation of prior art jitter buffer control mechanisms and methods;

FIG. 4a is a diagram of an exemplary network environment of the present invention;

FIG. 4b is a diagram of the terminal of the present invention;

FIG. 5 is a flow chart detailing the method of the present invention;

FIG. 6 is a diagram useful in understanding the present invention and determining the Time To Play (TTP) for each packet;

FIG. 7 is a Table of a TTP statistic in accordance with the present invention;

FIGS. 8 and 9 are charts detailing the operation of the jitter buffer and control mechanisms of the present invention as compared to those of the prior art;

FIG. 10 is a table based on a TTP statistic for an Example of the present invention; and

FIG. 11 is chart of jitter buffer size (in milliseconds) versus time (time intervals at which a TTP statistic was analyzed) comparing the present invention to the conventional art, for the Example of the Present Invention.

There is also included Appendix A, a computer program.

### DETAILED DESCRIPTION OF THE DRAWINGS

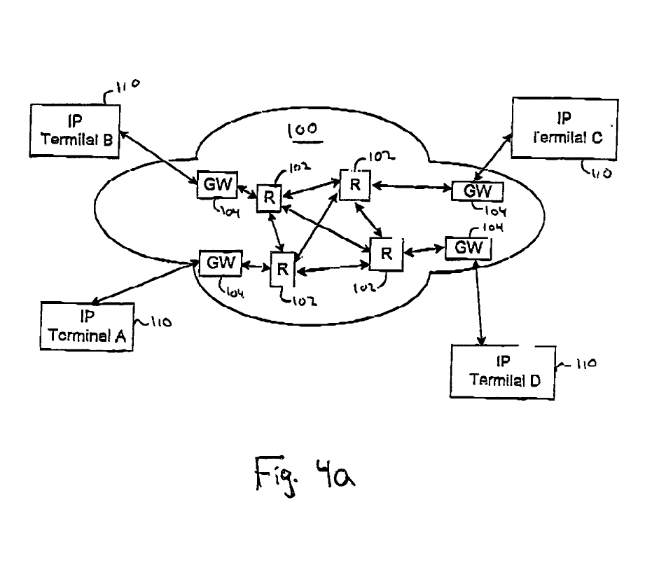

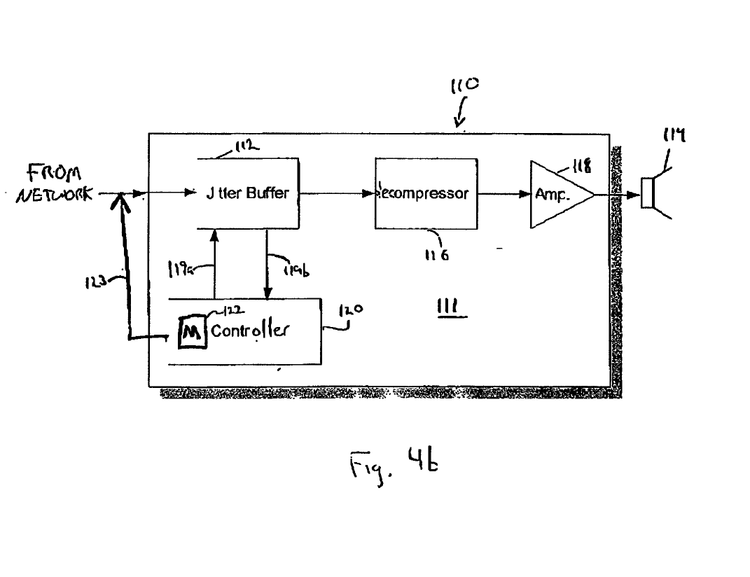

Reference is now made to FIG. 4a, which is shows the environment for the present invention, i.e., a network 100, the Internet being an example of one such network. Within the network 100 are various router (R) 102 and gateways (GW) 104, linked in a networked arrangement. Various communication devices, such as Internet Protocol (IP) terminals 110 are linked to the network 100 through gateways 104. Data packets, including audio packets, hereinafter “packets” travel over the network 100.

FIG. 4b shows a receiver section 111 (or receiver) of an IP terminal 110 in accordance with the present invention. This receiver 111 is preferably an audio receiver, and includes a jitter buffer 112 linked to a speaker 114 or the like, via a decompressor 116 and an amplifier 118. The jitter buffer is also linked (by wired or wireless links 119a, 119b) to a controller 120, that controls (adjusts) the size of the jitter buffer.

The jitter buffer 112 can be any conventional jitter buffer, for accommodating these packets, and for example, may be the jitter buffer detailed in U.S. Pat. No. 5,825,771. The decompressor 116 and amplifier 118 may also be conventional devices. The speaker 114, can be a conventional speaker and can be one associated with a personal computer (PC) designed to handle telephonic applications.

The controller 120, as detailed above, is preferably computer or microprocessor controlled. The controller 120 preferably includes, or alternately is linked to, a microprocessor (not shown) or other similar computing or processor means, for running software, as well as performing other computing functions, so as to signal or otherwise control the controller 120, to properly adjust (increase or decrease) or maintain the size of the jitter buffer 112. There may also be a storage unit for data and hardware associated with these microprocessor or other similar computing or processor means.

The method of the present invention is performed as follows and may include software and additional hardware in addition to the hardware detailed above. This method is detailed in FIG. 5 in the form of a flow chart.

Initially, at step 200, the Time To Play (TTP) for each packet is measured. Here TTP is defined as the amount of time a packet (regardless of the number of frames contained therein) of any size will wait in the jitter buffer 112 to be played. TTP for packets is measured by monitoring the network (including monitoring for bursts or burst periods as detailed below), this monitoring typically performed by monitoring means (M) 122, including hardware, software or combinations thereof in the controller 120. For example, the monitoring means 122 may include single or multiple samplers that monitor input to the receiver 111 from the network along the arrow 123.

Typically, the TTP for each of the packets is determined when packets are received at any designated location. When a packet is received, it typically has a time stamp and a sequence number, as detailed in RFC 1889, at Chapter 5 (including all of its subchapters), the entire RFC 1889 publication incorporated by reference in its entirety herein. TTP can then be measured as a function of the difference in times between timestamps of consecutively sequenced packets and the stamping frequency for the timestamp.

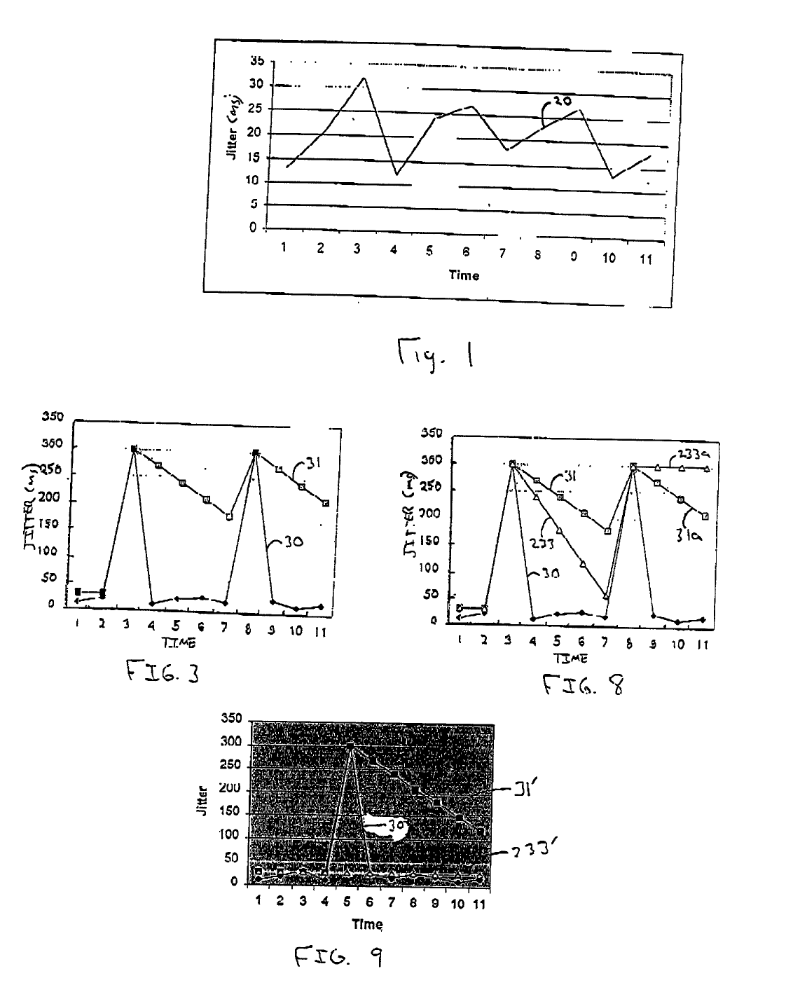

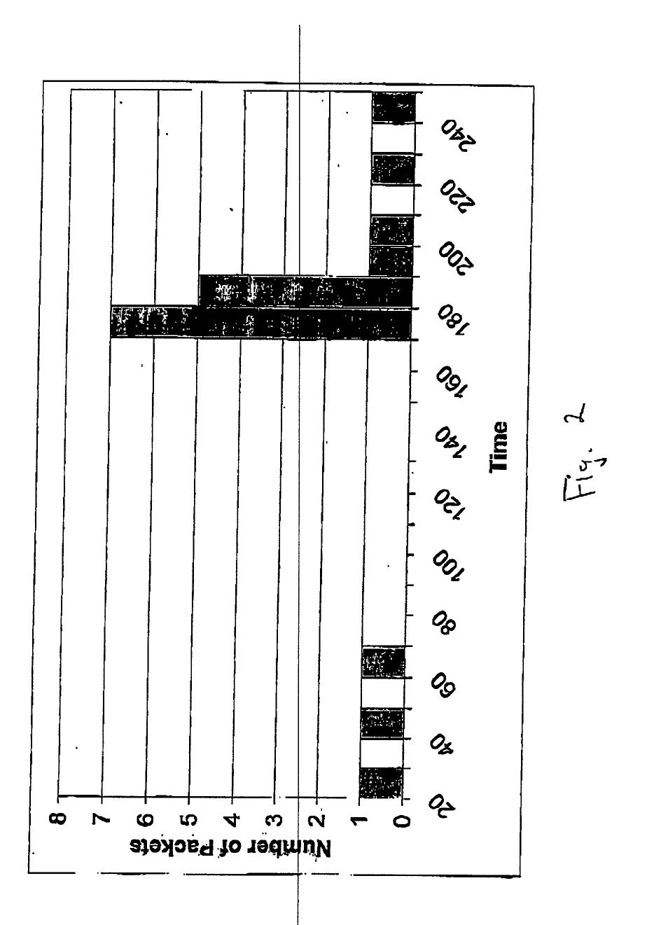

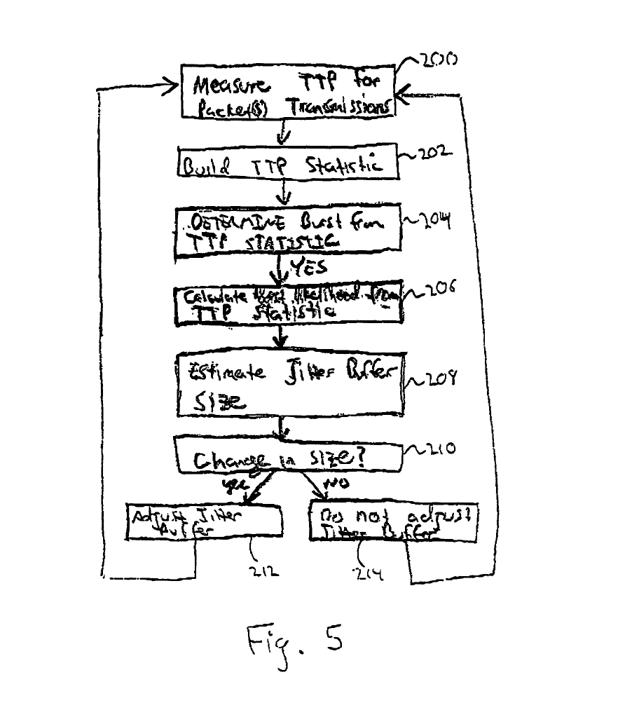

Typically, each terminal 110, has a jitter buffer, to compensate and overcome jitter in the network. FIG. 6 is a diagram for measuring TTP for packets, shown as P1-P7, transmitted in an audio stream, using G 723 codec for audio compression, and decompression for each packet. Each packet P1-P7, also includes a time stamp (in accordance with that detailed above), shown on packet P1, for example, as indicated by the circle labeled TS, that for packet P1 is 0. Similarly, packet P2 has a timestamp of 240 (indicated by the circle labeled TS), etc. Initially, at time 0 ms packets arrive (arrival indicated by the curved arrow AA) at the terminal 110, but are not played directly. Rather, they are delayed in the jitter buffer 112 (FIGS. 1 and 2) in order to build the jitter buffer (building starting at time 0 ms).

Starting at time 60 ms the approximate time when the jitter buffer has been built, packets begin to leave the jitter buffer at constant speed. Accordingly, at every 30 ms interval (30 ms is G.723 codec frame size), the next packet leaves the jitter buffer. Once a packet leaves the jitter buffer, and is received at a reference point along the audio stream, the packet size may be estimated. Size of packets is estimated based on knowing that G. 723 codec has an 8000 Hz sampling rate, such that the size of a packet (Pn) is estimated by the following equation:

Pn=(TS_{Pn+1}−TS_{Pn})/CSR (1)

where,

TS_{Pn+1} is the timestamp of the subsequent packet;

TS_{Pn} is the timestamp of the packet for which measurement is desired; and

CSR is the codes sampling rate (here 8000 Hz).

Employing this equation, P1 packet size is (240−0)/8000 or 30 ms Hz, P2 is 30 ms, etc. Identical calculations may be made for succeeding packets, whereby succeeding packets P3-P7, in this example are 30 ms in size.

With packet size known, and continuing to refer to FIG. 6, time to play (TTP) for each packet can be calculated. As shown in this diagram, packets leave the jitter buffer every 30 ms, after time 60 ms (packets leaving being indicated by the arrows PL). Specifically, packet P1, with a time stamp of 0 ms leaves the jitter buffer and is played at time 60 ms, packet P2, with a time stamp of 240 ms leaves the jitter buffer and is played at time 90 ms, P3, with a time stamp of 480 ms leaves the jitter buffer and is played at time 120 ms, packet P4, with a time stamp of 720 ms leaves the jitter buffer and is played at time 150 ms, packet P5, with a time stamp of 960 ms leaves the jitter buffer and is played at time 180 ms, packet P6, with a time stamp of 1200 ms leaves the jitter buffer and is played at time 210 ms, and packet P7, with a time stamp of 1440 ms leaves the jitter buffer and is played at time 240 ms.

In determining TTP for each packet, the time stamps of the first played packet are subtracted from the time stamp of the newly arrived packet. This result is then divided by the G.723 codec sampling rate (8000 Hz). TTP for each packet (TTP) is expressed by the equation:

TTP=(TS_{NA}−TS_{FP})/CSR (2)

where,

TS_{NA} is the timestamp of the newly arrived packet;

TS_{FP} is the timestamp of the first to play packet; and

CSR is the codec sampling rate.

For example, beginning with packet P4, newly arriving at or shortly after time 60 ms, TS_{PA} is 720 ms (time stamp of P4), TS_{FTP} is 240 ms (timestamp of first to play packet—Packet P2, at time 90 ms—the set time) and CSR is 8000, the G.723 codec sampling rate. Thus, the TTP for packet P4 in accordance with the equation above is (720 ms−240 ms)/8000 or 0.06 seconds or 60 ms.

Packets P5 (timestamp of 960 ms) and P6 (timestamp of 1200 ms) arrive at or just after time 120 ms (at this time P4—time stamp of 720 ms, is the first to play packet), such that TTP for P5 is (960−720)/8000, or 30 ms, and TTP for P6 is (1200 ms−720 ms)/8000 or 60 ms. In the case of Packets P5 and P6, that arrive at the same time, their order could be switched, and if so, their TTP's would not be affected by their different arrival order. Similarly, packet P7, with a timestamp of 1440 ms, arrives sometime after time 210 ms, and at set time 240 ms, TTP for P7 is (1440 ms−1440 ms)/8000 is 0 ms.

This information can then be used in building a TTP statistic, at block 202 of FIG. 5. Specifically, data corresponding to the time interval between time 60 ms and 240 ms for the TTP statistic is as follows:

| | TTP | | | | |
|---|---|---|---|---|---|
| | −30 | 0 | 30 | 60 | 90 |
| No. Of Packets | 0 | 1 | 1 | 2 | 0 |

In accordance with this TTP statistic, one packet P7 had a TTP of 0 ms, one packet P5 had a TTP of 30 ms, two packets P4 and P6 both had a TTP of 60 ms, and zero packets had a TTP of 90 ms. Negative TTP's (here −30 ms) is assigned to late arriving packets (in the jitter buffer). These packets are not played in the jitter buffer, but the information provided with each late arriving packet is preferably used for increasing jitter buffer size.

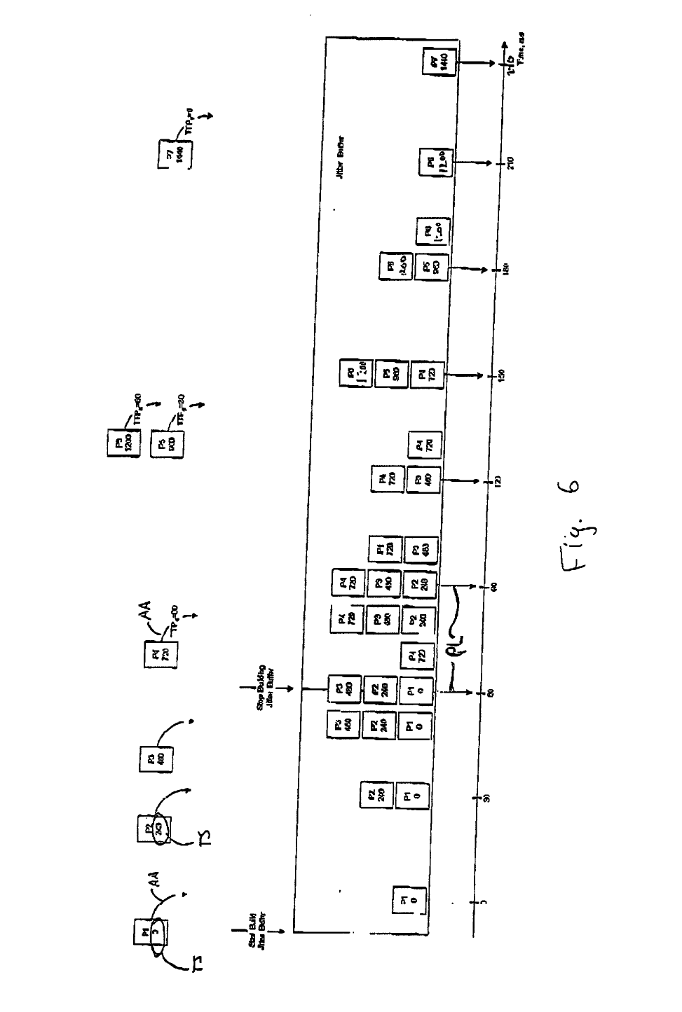

These lines (cach a TTP statistic) are then built in to a TTP statistic over a time period. FIG. 7 shows a table that is an actual experimentally determined TTP statistic in accordance with the present invention. The number of packets having certain TTP's was evaluated at various intervals, time 0, the 874 ms after time 0, then 1627 ms later (than time 874 ms), then 3247 later (than time 874 ms+time 1627 ms), etc. This TTP statistic is stored in microprocessor memory or other similar memory or storage device (or unit) in the terminal 110, preferably in the controller 120, or external thereto.

Additionally, from this TTP statistic, each line has values known as a “width” and an “offset”. The Width is the difference between the largest TTP and the smallest TTP, and the Offset is the lowest TTP where a packet was received. For example, for line “1” (or Histogram #1), the Width is 60 ms; calculated from 90 (5 packets received with TTP of 90 ms) minus 30 (5 packets received with TTP 30 ms) and the Offset is 30 ms, TTP 30 ms being the lowest TTP where a packet(s), (here 5 packets) were received.

With the TTP statistic built, this statistic is analyzed to determine if there is a burst (burst period) in block 204. The determination of the burst or burst period is determined by an analysis of the TTP statistic as bursts or burst periods are functions of above detailed offset and width values.

For example, in the TTP statistic of FIG. 7, lines “12” and “13” (Histogram #s 12 and 13) are indicative of a burst as the difference in width between lines 12 and 13 is 300 (480—line 13 minus 180—line 12), this width change being greater than approximately 200. Moreover, this burst or burst period is also indicated from lines “13” and “14” (Hystogram # 13 and 14) where the offsets have shifted by approximately 200 or greater (to the right). Specifically the offset has gone from −120 (line 13) to 240 (line 14).

Once there has been a burst, the likelihood of a subsequent burst is calculated from the TTP statistic at block 206. The likelihood of a subsequent burst is also function of the Offset and Width values (detailed above) from the TTP statistic. Generally, the likelihood of a subsequent burst, increases with each burst. The actual analysis for determining the burst or burst period likelihood, is a statistical analysis, in accordance with that detailed in Appendix A below.

With the likelihood of a subsequent burst or bursts calculated, in block 206, the jitter buffer size can be estimated, in block 208, based on this likelihood. The estimated jitter buffer size is determined from a statistical analysis, in accordance with that detailed in Appendix A below. This estimated jitter buffer size and present jitter buffer size, as measured (above) are compared at block 210 (change in size).

If a change in size is to be made, either increasing or decreasing the jitter buffer, at block 212, the controller 120 signals the jitter buffer, that has the corresponding hardware to increase or decrease its size in accordance with the signal from the controller. With the jitter buffer adjusted, the system returns to block 200 to start again. This method can be repeated for as many time intervals as desired.

FIG. 8 shows jitter buffer size being adjusted in accordance with the present invention in view of network behavior. Line 30 (formed of diamond shaped points) represents the present invention, and line 31 (formed of square shaped points) represents the prior art jitter buffer size adjustment methods, both as detailed in FIG. 3 above. Here, a first burst or burst period has been detected, at time interval 3. Based on the method detailed above, the likelihood of a second burst has boon determined as low. However, at time interval 8, a second burst has been detected, and now, in accordance with the method of the invention, the likelihood for a subsequent burst or burst period is high. Between time intervals 3 and 8 the jitter buffer of the invention, indicated by line 233 formed by triangular shaped points, is adjusted so as to decrease jitter buffer size at a substantially constant rate, until the next, here the second, burst or burst period. This behavior is similar to that of the prior art, in line 31.

After the second burst at time interval 8, the likelihood of a subsequent burst or burst period is highly probable. In accordance with the present invention, the jitter buffer is then kept at the level of the burst or burst period that it was raised to, in order to accommodate the anticipated burst or burst period, as shown by line segment 233a between time intervals 8-11. By remaining at this level, the jitter buffer can accommodate subsequent bursts or burst periods. This is in contrast to the prior art, that again, rises for the burst and then drops immediately at a substantially constant rate (line segment 31a). This immediate drop, serves to immediately decrease jitter buffer size as the prior art can not differentiate between bursts and jitter, and thus, treats all events as jitter. As a result of this failure to keep the jitter buffer at a size large enough to accommodate the subsequent burst or burst periods, the audio transmission experiences substantial breaks.

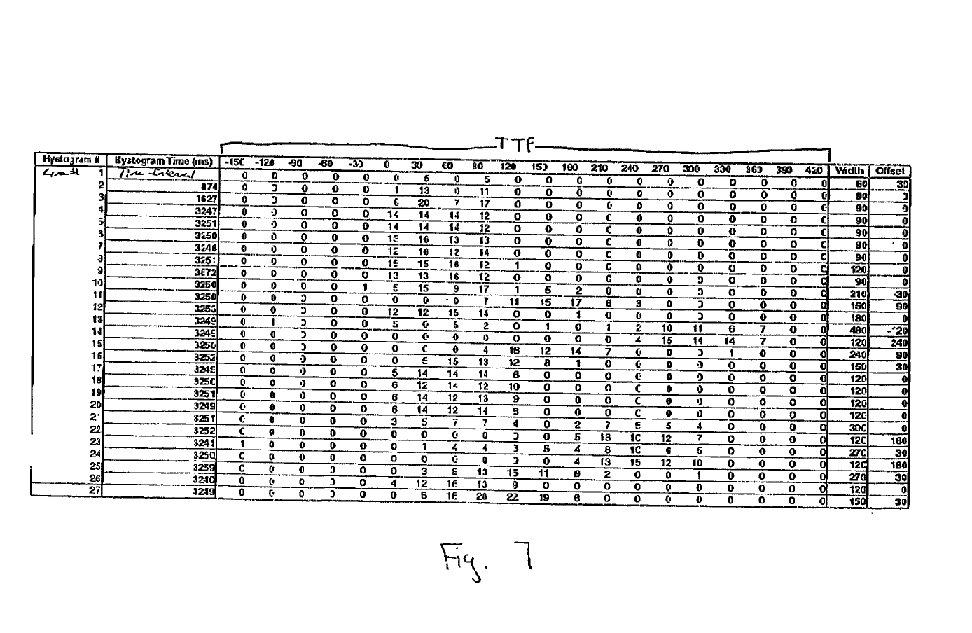

If a change in size is not made, the jitter buffer is not adjusted, at block 214, and the system returns to block 200 to start again. This is detailed in FIG. 9, where a lonely burst in the network (line 30), shown graphically by a spike at time interval 5, has been detected. With the probability of a second or subsequent burst being low, the jitter buffer size, represented by line 233′, formed of triangular shaped points, remains the same. Although some audio is lost as a result of the burst, there is not any reason to raise the jitter buffer since, in accordance with the TTP statistic (detailed above) a subsequent bust or burst period has been determined to be unlikely. This is different than the prior art, shown by line 31′ (similar to line 31 detailed above), where the burst or burst period (indicated by the spike) is treated like jitter and thus the buffer automatically adjusts, and is forced to be larger than necessary, between time intervals 6-11, such that audio transmission is delayed.

The above detailed steps, indicted at blocks 204 214 may be performed by an algorithm, identical or similar to that of Appendix A, below. This algorithm could be implemented by software, hardware, or combinations of both in the terminal 110, with the computing devices provided therein.

### EXAMPLE

### Jitter Buffer Calculation and Adjustment

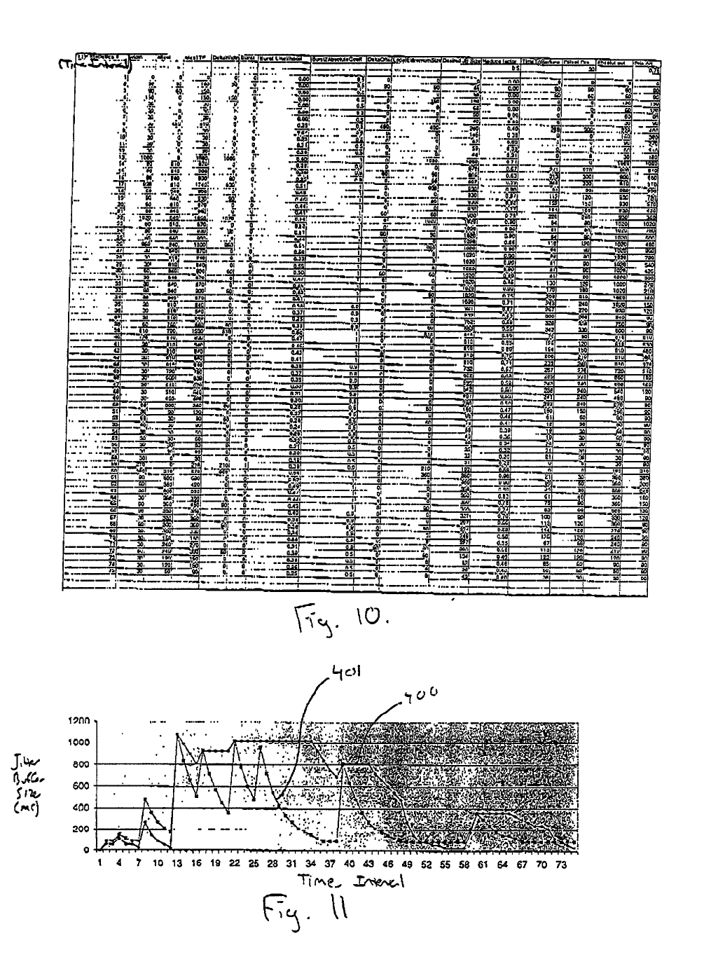

This Example makes reference to FIGS. 10 and 11 and the Algorithm of Appendix A, listed as a computer program, for implementation by software. In this example, the present invention was analyzed against prior art jitter buffers and methods for their control from TTP statistics (indicated by TTP statistic # or time interval no., col. 1 of FIG. 10), each TTP statistic taken at an increasing time interval (this time interval in milliseconds). The results were plotted graphically in FIG. 11, with the present invention formed of diamond shaped points, each point corresponding to a TTP Statistic # (col. 1 of FIG. 10) and the line formed from these points indicated by the number 400, and the conventional jitter buffer adjustment technique, formed of square shaped points, each point corresponding to a TTP Statistic # and the line formed from these points indicated by the number 401. The values determined in the table of FIG. 10, were obtained by the algorithm detailed in Appendix A.

At TTP Statistic # 8, a first burst or burst period has been detected. This causes the burst likelihood to increase to 0.25. This is in contrast to the conventional art jitter buffer and control methods therefor, where the jitter buffer is set according to the last (most recent) measurement, resulting in an increased delay. With the present invention, the jitter buffer grows slightly from this point, but remains relatively low, since here, the burst likelihood for a subsequent burst is still low, whereby delay remains low.

A second burst is detected at TTP Statistic #13, increasing the burst likelihood to 0.4. At this TTP statistic, the Burst2AbsolutCoff (from Appendix A and the definitions provided above) (FIG. 10, col. 8) grows to 1. A third burst is detected at TTP Statistic # 22, and after this third burst, the Burst2AbsoutCoff remains 1 for a substantial time (to TTP Statistic #34). When the Burst2Absoutcoff is “1” and considered to be “high”, jitter buffer size is adjusted according to the burst size. The adjustments made grow the jitter buffer to 1080 ms at TTP Statistic 13, and the jitter buffer remains at this size until larger bursts result in jitter buffer growth to 1020 ms, corresponding to TTP Statistic #22.

At Time 22 on the graph (FIG. 11), corresponding to TTP Statistic # 22, the difference between the invention, line 400 and the conventional art, line 401 is noticeable. In the conventional art, the jitter buffer is reduced after the spike, since there are not any additional spikes until Time 39 (corresponding to TTP Statistic # 39). In accordance with the present invention, as detailed above and Appendix A, jitter buffer size is not reduced, since the burst likelihood is still high, and remains high to about Time 43 (corresponding to TTP Statistic # 43). Moreover, the burst at TTP Statistic # 39 causes little, if any, audio degradation.

With the last large burst occurring at Time 39, subsequent bursts are decreasingly smaller. At Time 39 there is a last large bust, which the conventional art method can not adjust for, and thus causes audio degradation. This is in contrast to the present invention, that adjusts the jitter buffer to accommodate subsequent bursts or burst periods, and substantially reduces audio quality degradation. As the burst or burst periods decrease, the present invention and conventional art behave similarly.

While preferred embodiments of the present invention have been described so as to enable one of skill in the art to practice the present invention, the preceding description is exemplary only, and should not be used to limit the scope of the invention. The scope of the invention should be determined by the following claims.

What is claimed is:

1. A method for controlling jitter buffer size for a jitter buffer of a communication device for communication with a network, the method comprising the steps of:
monitoring said network for at least one burst period;
determining a likelihood for at least one subsequent burst period from said at least one burst period; and
adjusting said jitter buffer size based on said likelihood for said at least one subsequent burst period.

2. The method of claim 1, wherein said step of adjusting said jitter buffer size is in accordance with the detection of said at least one subsequent burst period.

3. The method of claim 1, wherein said step of monitoring said network includes:
measuring a time to play for each packet received at a predetermined location;
building a time to play statistic by creating at least two statistics from each of said received packets from at least two predetermined time intervals;
calculating the width and offset values from each of said at least two statistics; and
determining said likelihood of said at least one subsequent burst period from said widths and offsets of said time to play statistic.

4. The method of claim 2, wherein said step of adjusting said jitter buffer size includes, estimating said jitter buffer size and adjusting said jitter buffer size in accordance with said estimate.

5. The method of claim 1, wherein said step of monitoring said network for said at least one burst period includes monitoring said network for one burst period.

6. The method of claim 3, wherein said step of determining said likelihood of said at least one subsequent burst period includes performing a statistical analysis of said at least one subsequent burst period.

7. A method for controlling jitter buffer size for a jitter buffer of a communication device for communication with a network, the method comprising the steps of:
monitoring data packet transmissions in said network, including monitoring said data packet transmissions to detect at least one burst period;
building a time to play statistic by creating at least two statistics from each of said received packets from at least two predetermined time intervals;
calculating the width and offset values from each of said at least two statistics;
determining the likelihood of at least one subsequent burst period based on said width and offset values of said time to play statistic, provided there has been said at least one burst period; and
estimating said jitter buffer size to accommodate data packet transmissions of said at least one subsequent burst period based on said time to play statistics provided there has been said at least one burst period.

8. The method of claim 7, additionally comprising:
building said jitter buffer to accommodate said data packet transmissions of said at least one subsequent burst period in accordance with said estimate.

9. An audio receiver comprising:
a jitter buffer; and
a controller for said jitter buffer, said controller programmed to:
monitor said network for at least one burst period; and
to adjust said jitter buffer size based on said monitoring said network for said at least one burst period.

10. The audio receiver of claim 9, additionally comprising a storage unit in operative communication with said controller.

11. The audio receiver of claim 9, additionally comprising a decompressor in communication with said jitter buffer.

12. The audio receiver of claim 9, additionally comprising an amplifier in communication with said decompressor.

13. An audio receiver comprising;
a jitter buffer;
means for monitoring a network for at least one burst period; and
means for adjusting said jitter buffer to a size in accordance with said monitoring of said network for said at least one burst period.

14. The audio receiver of claim 13, wherein said network monitoring and adjusting means includes, a controller programmed to monitor said network for at least one burst period and to adjust said jitter buffer size based on said monitoring said network for said at least one burst period.
